(19) United States
(12) Patent Application Publication
(10) Pub. No.: US 2011/0100908 A1
(43) Pub. Date: May 5, 2011

(54) Waste Water Treatment

(76) Inventor: Thomas Stephenson, Bedfordshire (GB)

(21) Appl. No.: 11/597,064

(22) PCT Filed: May 20, 2005
(86) PCT No.: PCT/GB05/01963

§ 371 Date: Sep. 26, 2007

(30) Foreign Application Priority Data
May 20, 2004 (GB) 0411215.7

(51) Int. Cl. C02F 3/02; C02F 3/30

(52) U.S. Cl. 210/620; 210/630; 210/903

(57) ABSTRACT

In the treatment of domestic and municipal waste water environmental pollutants, such as ammonia, oxides of nitrogen, organic matter which gives rise to what is known as chemical oxygen demand (COD) [and biological oxygen demand (BOD)], and solid matter, should be removed from the waste water In a typical treatment process the waste water is treated to remove ammonia, firstly by nitrification—the biological oxidation of ammonia (NH₃) to nitrite (NOD₂⁻) and then to nitrate (NOD₃⁻)—and, secondly, by de-nitrification—the conversion of the formed nitrite or nitrate to nitrogen gas (N₂). Domestic and municipal waste water normally contains bacteria which will perform this treatment. By carefully adjusting the process conditions, the present invention seeks to provide a process by which waste water is subjected to nitrification to produce nitrite in the presence of an internal carbon substrate, and, preferably, by which this nitrite-laden waste water is then subjected to de-nitrification to produce nitrogen gas, with the carbon being converted to carbon dioxide and biomass.

This invention relates to the treatment of waste water containing ammonia and chemical oxygen demand (COD).

The following words have the following meanings for the purposes of the present Specification:
‘Aerobic’ means (requiring) the presence of air or oxygen.
‘Oxic’ means (requiring) the presence of oxygen.
‘Anoxic’ means (requiring) the absence of oxygen, but the presence of an alternative electron acceptor (source of oxygen), e.g. nitrite or nitrate.
‘Anaerobic’ means (requiring) the absence of oxygen and other electron acceptors.

For aerobic systems in waste water treatment, the dissolved oxygen concentration is usually 0.5 to 2.0 mg/l.

For anaerobic systems in waste water treatment, the oxygen concentration is 0 mg/l.

In the treatment of domestic and municipal waste water, so as to produce water which is suitable to be returned to the watercourse, environmental pollutants, such as ammonia, oxides of nitrogen, organic matter which gives rise to what is known as chemical oxygen demand (COD) [and biological oxygen demand (BOD)], and solid matter, should be removed from the waste water. In fact, the removal of nitrogen and oxides of nitrogen is often a legal requirement. Typically, the concentration of ammonia in aqueous ammoniacal waste, such as domestic and municipal waste water, is between 10 mg/l and 80 mg/l, and that of COD between 200 mg/l and 800 mg/l, whereas the maximum allowable concentrations in water to be returned to the watercourse are often in the regions of 1 to 10 mg/l ammonia and 100 to 125 mg/l COD. Owing to variations in the concentrations of the environmental pollutants in waste water, the pH of the waste water also varies.

In a typical treatment process the waste water is treated to remove ammonia, firstly by nitrification—the biological oxidation of ammonia (NH₃) to nitrite (NO₂⁻) and then to nitrate (NO₃⁻)—and, secondly, by de-nitrification—the conversion of the formed nitrite or nitrate to nitrogen gas (N₂).

Domestic and municipal waste water normally contains bacteria which will do this treatment—these bacteria being both heterotrophic bacteria, which require an organic carbon substrate (that is to say, a source of carbon) for nourishment, and autotrophic bacteria, which require an inorganic carbon substrate for nourishment. The heterotrophic bacteria are responsible for the removal of COD from the waste water by feeding upon any carbon present in the waste water. Some of the autotrophic bacteria are so-called nitrifiers; they are responsible for both stages of nitrification. Therefore, it can be seen that the bacteria naturally present in waste water can remove both ammonia (via nitrifiers) and COD (via heterotrophic bacteria).

Nitrification takes place in two stages. First, the ammonia is oxidised to nitrite by bacteria of the genus Nitrosomonas and then the thus-formed nitrite is subsequently oxidised to nitrate by bacteria of the genus Nitrobacter (in fact, in the presence of an excess of oxygen the oxidation does not usually stop at nitrite but continues through to nitrate).

Nitrification can be described stoichiometrically as:
Stage 1: NH₃+1.5O₂→NO₂⁻+H⁺+H₂O
Stage 2: NO₂⁻+0.5O₂→NO₃⁻
Overall: NH₃+2O₂→NO₃⁻+H⁺+H₂O
   The process uses air as its provider of oxygen, this being a relatively cheap supply of oxygen. The air is pumped, at some cost, into the waste water. From the stoichiometric equations above, it can be seen that the oxidation of ammonia to nitrite consumes 25% less oxygen than the oxidation of ammonia to nitrate—a point that shall be returned to later.

The autotrophic nitrifiers, such as Nitrosomonas and Nitrobacter, are slower-growing than the usual heterotrophic COD-removing micro-organisms and are more sensitive to operating conditions such as pH, the amount of dissolved oxygen, and the presence of toxins. Therefore, if a reactor system receiving waste water containing both ammonia and COD is designed to remove the ammonia using the biological action of the nitrifiers, the COD will also be removed by the biological action of heterotrophic bacteria.

The waste water now containing nitrite and nitrate instead of ammonia can be subsequently subjected to de-nitrification to effect the conversion of the nitrite and/or nitrate to nitrogen gas. In the treatment, this conversion is effected using facultative bacteria—which are heterotrophic—and, as noted above, require an organic carbon substrate, the treatment being, also, effected in the absence of oxygen. When carrying out the conversion, the bacteria use the nitrite or nitrate as the final electron acceptor for the breakdown of the organic carbon.

De-nitrification can be described stoichiometrically (using methanol as the carbon substrate) as:
Nitrite: 6NO₂⁻+3CH₃OH→3N₂+3CO₂+3H₂O+6OH⁻
Nitrite: 6NO₃⁻+5CH₃OH→3N₂+5CO₂+7H₂O+6OH⁻
   In most current systems the COD contained in the waste water is removed (by the heterotrophic bacteria) in the nitrification stage of the process, so that more COD, often in the form of methanol, has to be added, thereby incurring additional cost. From the above stoichiometric equations, it can be seen that 40% less carbon is required for the de-nitrification of nitrite than that of nitrate.

Thus, the two-stage nitrification and de-nitrification process converts ammonia to nitrogen gas via nitrite and/or nitrate. Overall, if ammonia is converted to nitrogen gas via nitrite, 25% less oxygen (as noted above) and 40% less carbon are used, thus greatly reducing the overall costs incurred when compared with the conversion via nitrate. It is, therefore, preferred that the de-nitrification of waste water be carried out only via the intermediate of nitrite.

As discussed above, de-nitrification of nitrified domestic/municipal waste water is achieved using a carbon substrate. The substrate can be added to the waste water—an external carbon system, such as the methanol mentioned above—or it can already be present in the waste water—an internal carbon system—if it has not already been used up.

Generally, an external carbon system involves a two-stage process whereby in the aerated first stage (in which nitrification to nitrite and/or nitrate occurs) the influent waste water (high in ammonia and COD, low in nitrate) is treated (some of the sludge being re-cycled) to produce a low ammonia, low COD, high nitrate effluent, and secondly this effluent is supplemented with more (external) COD, and the whole then undergoes a further (but anoxic) treatment, whereby the nitrate is converted to nitrogen gas (de-nitrification), the COD being converted to carbon dioxide. This process involves adding a carbon substrate (such as glucose, molasses, methanol, ethanol, or acetate) to the waste water.

An internal carbon denitrification system on the other hand is—as exemplified by a two-stage modified activated sludge process—one in which, in the first stage, de-nitrification to nitrogen gas occurs later on and, in the second stage, nitrification to nitrite and/or nitrate occurs. This is done by having an anoxic (no aeration) first stage followed by an aerobic second stage. There is likely to be COD forwarded from the first stage to the second stage, as not all of it might be used in the anoxic denitrification stage. However, nitrification can occur in the absence of organic carbon. The influent waste water (high in ammonia and COD, low in nitrate) passes through the anoxic stage producing an effluent which is still high in ammonia but medium in COD (and low in nitrate), and in the second stage, the ammonia is converted under aerobic conditions to nitrate, with some of this nitrate being recycled back to the anoxic stage influent. As there is no oxygen in the anoxic stage, de-nitrification of the nitrate to nitrogen gas occurs (using the COD). Overall, the second stage output ends up being low in ammonia, nitrate and COD. This system does, however, necessitate the use of a mixed liquor recycle that is approximately four times the influent flowrate.

Both of these present-day external and internal carbon systems incur considerable extra costs. In the external system, they are the costs involved in buying the carbon substrate, and in the internal system, they are the costs involved in pumping the mixed liquor recycle stream.

To reduce raw material costs it is desirable that the de-nitrification stage start from nitrite—and for the same reason it is also desirable to use an internal rather than external carbon substrate. This present invention aims to achieve these desiderata—it seeks to provide a process by which waste water is subjected to nitrification to produce nitrite in the presence of an internal carbon substrate, and, preferably, by which this nitrite-laden waste water is then subjected to de-nitrification to produce nitrogen gas, with the carbon being converted to carbon dioxide and biomass.

According to one aspect of the present invention, there is provided a nitrification process in which aqueous ammoniacal waste, which is low in nitrite, high in chemical oxygen demand (COD) and high in ammonia, is treated under conditions which result in an effluent that is high in nitrite, high in COD and low in ammonia.

Particularly advantageously, the aqueous waste is low in nitrate and the effluent is no more than medium in nitrate. In other words, the effluent is higher in nitrite than in nitrate.

It is to be understood that being low in a constituent includes the possibility that that constituent is absent.

According to another aspect of the present invention, there is provided a nitrification process of treating aqueous ammoniacal waste that contains chemical oxygen demand (COD), in which process the effluent therefrom has, compared with the influent aqueous waste, an increased concentration of nitrite, a reduced concentration of COD and a reduced concentration of ammonia.

It will be understood that the increased concentration of nitrite could be from zero and that a reduced concentration could be to zero.

Preferably, the nitrification process results in an effluent in which the concentration of nitrite is at least doubled, the concentration of COD is less than what it was and the concentration of ammonia is at least halved.

In practice, the nitrication process according to the invention could be expected to increase the nitrite concentration from virtually zero mg./l. to tens or hundreds of mg./l. and to reduce the ammonia concentration from tens or hundreds of mg./l. to tens of mg./l. or less, with the COD concentration undergoing a reduction of between 0 and 40%. The actual values will, of course, depend upon especially the composition of the influent waste.

More particularly this invention proposes a process of treating aqueous waste that contains ammonia and carbonaceous organic matter (COD), the treatment being to convert the ammonia to nitrogen by nitrification and de-nitrification, in which process:
a) the influent aqueous waste is caused to undergo nitrification by being digested by bacteria capable of converting ammonia to nitrite or nitrate, this being effected both in conditions capable of favouring the growth of Nitrosomonas and capable of inhibiting the growth of Nitrobacter and in the presence of air and vigorous agitation, so as to inhibit the growth of heterotrophic micro-organisms, so that the ammonia is nitrified to produce a first effluent that is high in nitrite, high in COD and low in ammonia; and
b) this first effluent is subsequently caused to undergo de-nitrification, in which the COD provides an internal carbon substrate for the anoxic conversion of the nitrite to nitrogen (and the COD to carbon dioxide), so as to produce a second effluent that is low in nitrite, low in COD and low in ammonia.

As noted hereinabove, the method of treating aqueous ammoniacal waste is by nitrification. The present nitrification process involves the utilisation of process conditions—such as the degree of aeration, the temperature, the hydraulic retention time [HRT] (which is affected by the pH of the aqueous waste, and that pH is itself affected by the influent ammonia concentration), and/or the amount of agitation—in a reactor to affect the bacteria naturally present in the aqueous waste, so that the Nitrosomonas prosper and the Nitrobacter and heterotrophic micro-organisms are inhibited, whereby mostly nitrite instead of nitrate is produced without significant removal of COD.

Aeration can be provided through one, but preferably a combination, of surface liquid turnover, owing to high intensity mixing, and air sparging using diffusers or other techniques, such as venturi nozzles.

The normal temperature range in which nitrification occurs is roughly 5° C. to 40° C. and preferably between 10° C. and 35° C.

The HRT of the waste water in the reactor is adjusted to optimise the production of nitrite as opposed to nitrate. This time is, however, affected by the pH of the aqueous waste, but is typically not more than 24 hours and more usually around 8 to 12 hours. It might be possible to increase the HRT in order to help overcome any detrimental effects a sub-optional pH may have on the conversion of ammonia to nitrite.

Agitation is provided by turbine-bladed impellors operated at high velocity, or by other methods such as venturi-type nozzle systems, or jet loop and airlift-type reactors. This agitation provides high intensity mixing in the reactor. The intensity of mixing is higher, preferably at least several times higher, than would be employed in a conventional process for treating similar waste.

As noted hereinabove, the pH of waste water varies according to its concentrations of environmental pollutants. However, an optimal pH for an influent waste water stream would normally be between 6.5 and 8.0. Furthermore, the degree of mixing can be increased by the use of a baffled reactor.

The treatment is conveniently effected in a purpose-built reactor of the single pass, completely-mixed aerobic type (a continuous stirred tank reactor [CSTR] being such a reactor), which can also be baffled.

Therefore, in this nitrification stage, ammonia is converted to nitrite with little or no breakdown of organic matter to give an effluent that contains relatively high concentrations of nitrite and COD and relatively low concentrations of ammonia and nitrate.

As noted hereinabove, a particular process of the invention is to convert ammonia into nitrogen and, thus, the formed nitrite-rich liquor must be further treated to achieve this. In the prior art, the nitrite-rich liquor is de-nitrified, using an external COD source, to give nitrogen and carbon dioxide. However, as explained above, it is more efficient to convert the nitrite directly to nitrogen using internal carbon, and such a process is proposed by a further aspect of this invention.

Thus, according to a further aspect of the present invention, there is provided a process of treating aqueous ammoniacal waste that contains chemical oxygen demand (COD), to remove therefrom ammonia and COD, in which process the waste is subjected first to nitrification with little or no removal of COD, and the thus-treated waste is then de-nitrified using the remaining COD as an internal carbon source.

De-nitrification of the thus-treated waste involves the utilisation of process conditions—such as the HRT (which is affected by the pH of the nitrite-rich waste water—itself affected by the influent nitrite concentration and the temperature of the waste water)—in a non-aerated reactor to affect the bacteria naturally present in the aqueous waste, so that the heterotrophic micro-organisms prosper by using the COD still present in the waste water to convert the nitrite to nitrogen, with the COD being converted to carbon dioxide.

The HRT is adjusted upwardly or downwardly, depending upon conditions, to optimise de-nitrification and in relation to the pH of the nitrite-rich waste water. In relation to the temperature of the waste water, it would be between 5° C. and 40° C., preferably 10° C. to 35° C., and the temperature at which de-nitrification is performed would be roughly the same. The HRT is increased if the temperature falls.

The reactor can be any non-aerated reactor and the conversion can be achieved in any suitable way, but two good ways use either an anoxic suspended-growth system or an anoxic fixed-film reactor system. In the suspended growth system the bacteria grow in flocs which are suspended in the reactor liquor. The fixed-film system may take the form of a submerged deep bed sand filter or a reactor with a high voidage packing, such as random-fill plastics media. To maintain anoxic conditions, i.e. to encourage de-nitrification of the liquor, no air is added to the reactor.

It will be understood that de-nitrification is achieved using an internal carbon substrate without the need for a high rate mixed liquor recycle, or the purchase of an external carbon substrate. In addition, less oxygen is needed, which further reduces raw material costs.

In order that the invention may be clearly and completely disclosed, and readily carried into effect, embodiments of the nitrification and de-nitrification processes of the invention are now described, by way of illustration only, with reference to the Figures shown in the accompanying diagrammatic drawings, in which:

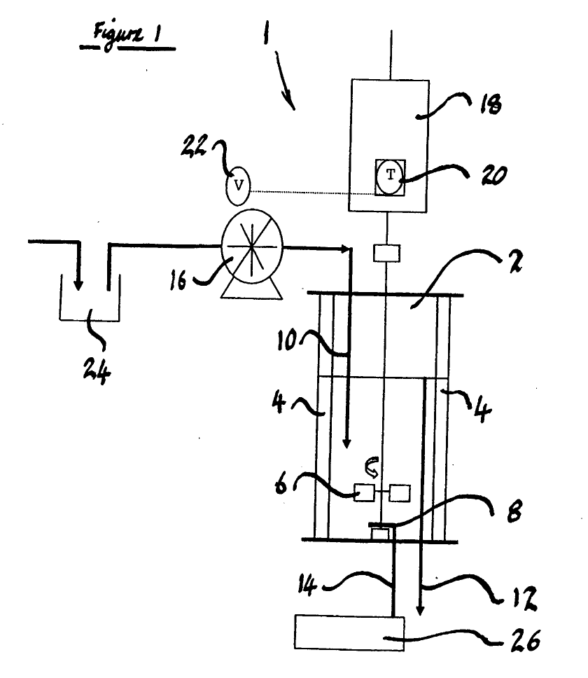

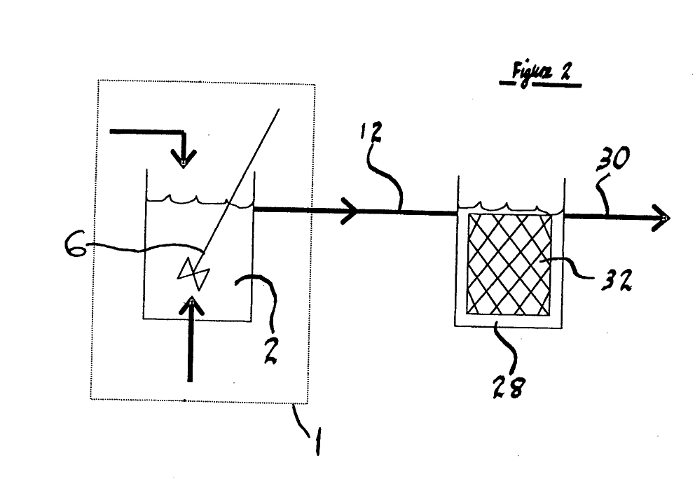

FIG. 1 is a schematic representation of one configuration of a high-intensity mixing aerobic reactor of the nitrification stage;

FIG. 2 is a schematic representation of a two-stage nitrification and de-nitrification system;

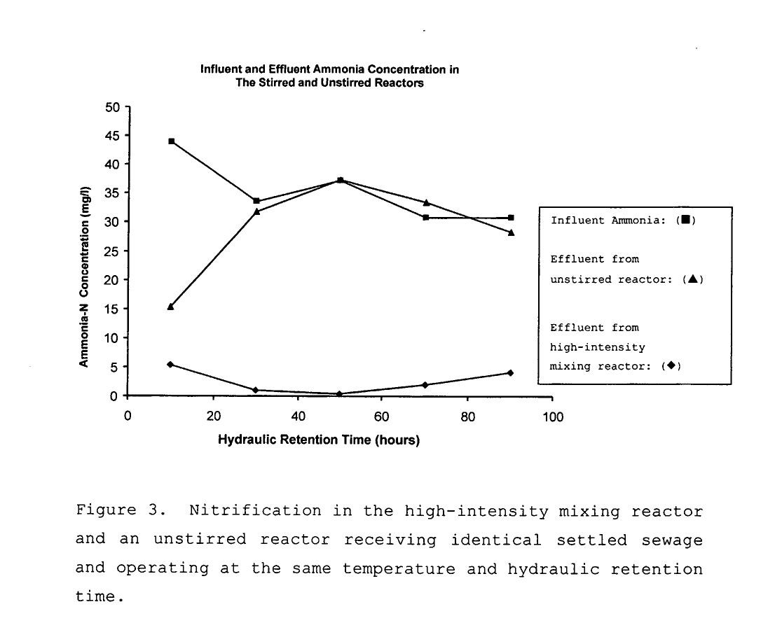

FIG. 3 is a graph showing influent and effluent ammonia concentrations for a high-intensity mixing reactor and an unstirred aerobic reactor operated in parallel, treating identical waste waters; and

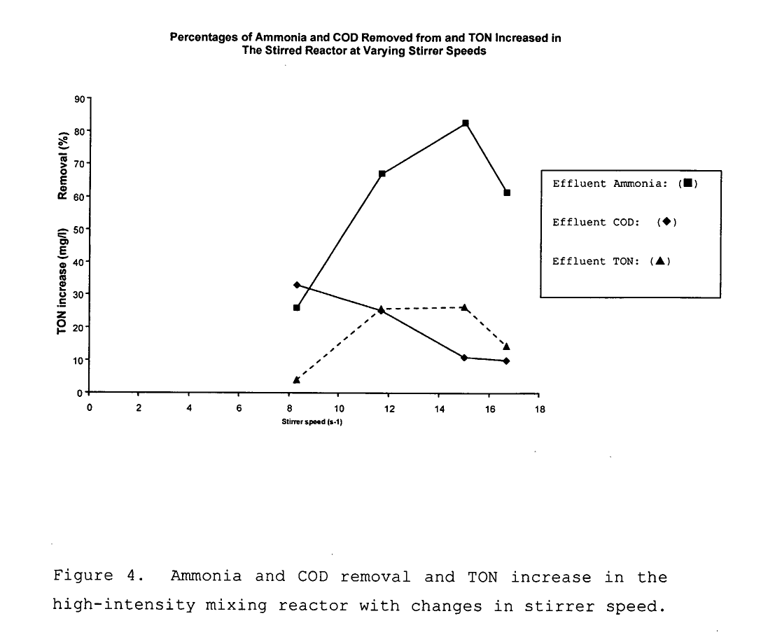

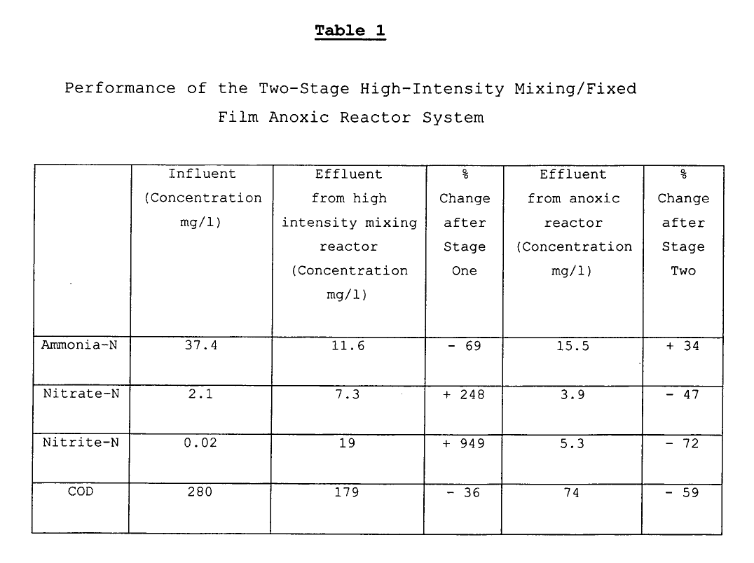

FIG. 4 is a graph showing the percentage of ammonia and COD removed from a high-intensity mixing reactor.

The reactor 1 of FIG. 1 is for the nitrification of aqueous ammoniacal waste that contains carbonaceous organic matter (COD).

Nitrification takes place in a high-intensity mixing, aerated reactor vessel 2, which has a capacity of 9 litres and was made up of a glass pipe section (229 mm internal diameter and 500 mm height) connected to a stainless steel base plate and lid using a flange with inserts and sealed using gaskets. The aerated reactor vessel 2 also comprises baffles 4, a six-bladed disc turbine impeller 6; a ring sparger 8, made from 12.7 mm stainless steel tube with a 40 mm outside diameter with five 6.35 mm holes cut into the underside; a waste water input 10; a waste water output 12; and an air input 14. The associated process equipment also includes a peristaltic pump 16, which was a 603 s from Watson Marlow, Falmouth, United Kingdom; an inverter and programme control module 18; a tachogenerator 20; a digital multi-meter 22; a waste water storage tank 24; and an air compressor 26.

Waste water arrives at the tank 24 and from there is pumped at a controlled rate, according to the gas hold-up and required retention time of the reacter, by the pump 16 into the aerated reactor vessel 2 via the waste water input 10. Air from the compressor 26, which is controlled by a float-type flow meter, is fed into the aerated reactor vessel 2 via the sparger 8, which disperses the air providing oxygen to the bacteria. The waste in the vessel 2 is, at the same time, subjected to high-intensity mixing by the impellor 6, which is aided by the baffles 4, to mix together the contents of the waste and further disperse the air. The inverter and programme control module 18 controls the motor power input while the tachogenerator 20 measures the rotational speed of the impellor 6, the output voltage of this being monitored by the digital multi-meter 22. Bacteria present in the waste water break down the ammoniacal-nitrogen to nitrite and the part-treated waste water effluent passes out of the aerated reactor vessel 1, via the waste water output 12, and on to further processing equipment.

In FIG. 2, the aerated reactor 1 of the nitrification stage is as hereinbefore described with reference to FIG. 1, with the addition that the waste water effluent of FIG. 1 becomes the influent waste water to an anoxic, fixed-film submerged reactor 28.

The anoxic reactor 28 has a volume of 2.5 litres without biomass and internal dimensions of 100 mm by 100 mm by 360 mm. The anoxic reactor also comprises a waste water input 12, a treated water output 30, and structural fill media 32 cut to fit the vessel up to a height of 300 mm, and constructed of open-structure modular plastic media having a voidage of circa 96%.

The influent waste water to the anoxic reactor flows, via the waste water input 12, into the top of the anoxic reactor 28. The waste water passes from top to bottom through the structural fill media 32, wherein the heterotrophic bacteria de-nitrify the nitrite in the waste water by using the nitrite as the final electron acceptor for the breakdown of the organic carbon, and the thus-treated waste water passes out of the reactor by the treated water output 30.

Examples of the process according to the invention will now be described.

### EXAMPLE 1

### Nitrification without COD Removal

Real settled sewage from a full-scale treatment works receiving a domestic sewage was fed into the high-intensity mixing reactor 1 at the Applicant University's private experimental works at a rate to maintain a hydraulic retention time of 10 hours. Simultaneously, the settled sewage from the same source was fed into an unstirred vessel at a rate in order to maintain the same hydraulic retention time of 10 hours. Both vessels were temperature-controlled at 34° C. The same airflow rate was supplied to both vessels, maintaining near dissolved oxygen saturation (at 87% and 90% of saturation for the high intensity mixing and unstirred reactors respectively; that there was no significant difference was checked using a student t-test, to ensure that this parameter could not limit nitrification). In the high intensity mixing reactor, the stirrer speed was set at 15 s⁻¹ (900 revolutions per minute).

Daily maintenance was scheduled to help show that the nitrification was occurring owing to suspended growth bacteria, and not through wall growth or direct stripping of ammonia to the atmosphere. The contents of the vessels were emptied daily into a bucket and the walls and pipework of the vessels were thoroughly cleaned. The unstirred reactor was seeded with the effluent from the stirred reactor. The systems were allowed to stabilise for at least six hydraulic retention times prior to sampling and samples for analysis were taken a minimum of one retention time apart. A total of 10 samples were taken for the experimental run, i.e. covering 10 retention times. Influent and effluent ammoniacal-nitrogen, nitrite-nitrogen and nitrate-nitrogen were analysed.

It can be seen from FIG. 3 that the influent ammonia was almost completely removed from the high-intensity mixing reactor 1; the ammonia removal averaged 93% over the 100 hours of operation. The presence of nitrification was confirmed by a corresponding increase in nitrite and nitrate in the effluent compared to the influent; nitrite and nitrate increased by 18.2 and 5.1 mg/l, respectively. In contrast, the effluent ammonia-nitrogen concentration from the unstirred vessel remained high; the ammonia removal averaged only 14% over the same period. As all conditions in both the high-intensity mixing and unstirred reactors were the same, except, of course, for the mixing, it was clearly demonstrated that mixing improved the nitrification process.

### EXAMPLE 2

### Ammonia and COD Concentrations as a Function of StirrerSpeed in a High-Intensity Mixing Reactor

The high-intensity mixing reactor was operated as described in Example 1. In a series of experimental runs the stirrer speed was increased from 8.3 to 16.7 s⁻¹ (500 to 1,000 revolutions per minute), again at a hydraulic retention time of 10 hours. A total of 8 sampling runs, were undertaken at stirrer speeds of 8.3 s⁻¹ (once), 11.7 s⁻¹ (twice), 15 s⁻¹ (four times) and 16.7 s⁻¹ (once). The amount of organic carbon was measured as chemical oxygen demand (COD), and influent and effluent ammoniacal-nitrogen, nitrite-nitrogen and nitrate-nitrogen amounts were also measured so as to calculate the variations in concentration thereof.

From FIG. 4, it can be seen that, as the stirrer speed was increased from 8.3 to 15 s⁻¹, the amount of nitrification increased. This was confirmed by a significant increase in Total Organic Nitrogen (TON—effluent nitrite and nitrate combined) in the effluent compared to the influent, as also shown on FIG. 4. At 15 s⁻¹ the overall nitrification rate was 83%, which represents a good nitrification rate, and nitrite constituted 73% of the effluent TON. Concomitant with the increase in nitrification, there was a decrease in COD removal; at 15 s⁻¹ this was only 11%. Therefore, an increase in mixing intensity improved nitrification at the same time as inhibiting the removal of chemical oxygen demand. In addition, ammonia oxidation was arrested mainly at nitrite instead of nitrate.

### EXAMPLE 3

### Nitrification without COD Removal, and De-Nitrification using the Internal COD

In this Example, tests were carried out on a two-stage nitrification/de-nitrification reactor system at the private works, as shown in FIG. 2. The first stage (high-intensity mixing reactor 1) was operated as described in Examples 1 and 2. The second, anoxic stage was the fixed-film submerged reactor 28. The effluent liquor from the stirred reactor flowed down an overflow pipe (12), and into the top of the secondary reactor 28. The secondary reactor volume without biomass was 2.5 litres.

The second, anoxic-stage reactor 28 received effluent with high nitrite concentrations from the high-intensity mixing reactor 1. The second, anoxic stage was operated at a 4 hour hydraulic retention time. Ten samples of influent and effluent from the high-intensity mixing reactor 1 and effluent from the anoxic reactor 28 were taken at 10 h intervals over a 100 h experimental run. All influent and effluent concentrations of chemical oxygen demand (COD) and all inorganic nitrogen compounds (ammonia, nitrite, nitrate) were recorded for both reactors. It can be seen from Table 1 (which summarises the performance, in terms of ammonia and COD removal of the two-stage nitrification/de-nitrification reactor system shown in FIG. 2), that removal of ammonia at 69% and COD at only 36% were good and poor, respectively,—which, more importantly, was the desired result. Therefore, a high Total Organic Nitrogen (nitrate and nitrite) concentration of 26.3 mg/l entered the anoxic reactor 28, along with a relatively high COD concentration of 179 mg/l. The TON was reduced by 65% with a concomitant reduction in COD of 59%, indicating that denitrification had taken place. A nitrogen balance on the results shown in Table 1 demonstrated that 37% of the influent nitrogen was unaccounted for: this indicates that the nitrogen was lost to the atmosphere as nitrogen gas and confirms that de-nitrification had taken place. It will be understood by those skilled in the art that the exact concentrations and thus percentages given in Table I would not necessarily be obtained in a full-scale commercial plant, but the values entered in the Table demonstrate trends the important ones of which would occur in such full-scale commercial plant.

I claim:

1-18. (canceled)

19. A nitrification process in which aqueous ammoniacal waste, which is low in nitrite, high in chemical oxygen demand (COD) and high in ammonia, is treated under conditions which result in an effluent that is high in nitrite, high in COD and low in ammonia.

20. A process according to claim 19, in which the aqueous waste is low in nitrate, and the effluent is no more than medium in nitrate and thus higher in nitrite than in nitrate.

21. A process according to claim 19, wherein, in said effluent compared with said waste, the concentration of nitrite is at least doubled, the concentration of COD is less and the concentration of ammonia is at least halved.

22. A process according to claim 19, wherein, in said effluent compared with said waste, the nitrite concentration is increased from virtually zero mg./l. to tens or hundreds of mg./l., and the ammonia concentration is reduced from tens or hundreds of mg./l. to tens of mg./l. or less, with the COD concentration undergoing a reduction of between 0% and 40%.

23. A process according to claim 19, in which aeration during the nitrification is effected through one, or a combination, of surface liquid turnover and air sparging.

24. A process according to claim 23, in which said surface liquid turnover is achieved by high intensity mixing using one or more of turbine-bladed impellor means operated at high velocity, venturi nozzle means, and a jet-loop or airlift reactor.

25. A process according to claim 19, in which the degree of mixing during the nitrification is increased by the use of a baffled reactor.

26. A process according to claim 19, in which the nitrification is effected at between 10° and 35° C.

27. A process according to claim 19, in which the hydraulic retention time of the waste in a reactor in which the nitrification is performed is from around 8 to 12 hours in order to optimize the production of nitrite as opposed to nitrate.

28. A process according to claim 19, in which the pH of said waste is, or is adjusted to be, between 6.5 and 8.0.

29. A process of treating aqueous ammoniacal waste that contains chemical oxygen demand (COD), to remove therefrom ammonia and COD, in which process the waste is subjected first to nitrification with little or no removal of COD, and the thus-treated waste is then de-nitrified using the remaining COD as an internal carbon source.

30. A process according to claim 29, which process involves the utilization of process conditions in a non-aerated reactor to affect the bacteria naturally present in the waste, so that the heterotrophic micro-organisms prosper by using the COD still present in the waste to convert the nitrite to nitrogen, with the COD being converted to carbon dioxide.

31. A process according to claim 30, in which the hydraulic retention time is adjusted upwardly or downwardly, depending upon conditions, to optimize de-nitrification and in relation to the pH of the waste.

32. A process according to claim 31, wherein the hydraulic retention time is increased if the temperature falls.

33. A process according to claim 30, wherein the de-nitrification is achieved using either an anoxic suspended-growth system or an anoxic fixed-film reactor system.

34. A process according to claim 29, in which the temperature of the waste is from 10° C to 35° C.

35. A nitrification process of treating aqueous ammoniacal waste that contains chemical oxygen demand (COD), in which process the effluent therefrom has, compared with the influent aqueous waste, an increased concentration of nitrite, a reduced concentration of COD and a reduced concentration of ammonia.

36. A process according to claim 35, wherein, in said effluent compared with said waste, the concentration of nitrite is at least doubled, the concentration of COD is less and the concentration of ammonia is at least halved.

37. A process according to claim 36, wherein, in said effluent compared with said waste, the nitrite concentration is increased from virtually zero mg./l. to tens or hundreds of mg./l., and the ammonia concentration is reduced from tens or hundreds og mg./l/ to tens of mg./l. or less, with the COD concentration undergoing a reduction of between 0% and 40%.

38. A process of treating aqueous waste that contains ammonia and carbonaceous organic matter (COD), the treatment being to convert the ammonia to nitrogen by nitrification and de-nitrification, in which process:
a) the influent aqueous waste is caused to undergo nitrification by being digested by bacteria capable of converting ammonia to nitrite or nitrate, this being effected both in conditions capable of favoring the growth of Nitrosomonas and capable of inhibiting the growth of Nitrobacter and in the presence of air and vigorous agitation, so as to inhibit the growth of heterotrophic micro-organisms, so that the ammonia is nitrified to produce a first effluent that is high in nitrite, high in COD and low in ammonia; and
b) this first effluent is subsequently caused to undergo de-nitrification, in which the COD provides an internal carbon substrate for the anoxic conversion of the nitrite to nitrogen and the COD to carbon dioxide, so as to produce a second effluent that is low in nitrite, low in COD and low in ammonia.
